(19) United States
(12) Patent Application Publication
(10) Pub. No.: US 2018/0051681 A1
(43) Pub. Date: Feb. 22, 2018

(54) PUMP ASSEMBLY FOR SPRAYING APPARATUS

(71) Applicant: Michael P. Wells, Dearborn, MI (US)

(72) Inventor: Michael P. Wells, Dearborn, MI (US)

(21) Appl. No.: 15/240,518

(22) Filed: Aug. 18, 2016

(51) Int. Cl. F04B 23/02; B05B 1/16; B05B 11/00; F04B 9/14; F04B 53/14; F04B 53/10

(52) U.S. Cl. CPC F04B 23/028; B05B 1/169; B05B 11/3011; F04B 53/10; B05B 11/3067; F04B 9/14; F04B 53/14; B05B 11/3039

(57) ABSTRACT

The present disclosure relates to a spraying apparatus for spraying a liquid onto a surface. The spraying apparatus includes a tank configured to store a liquid, a neck extending from the tank and defining an opening, a pump assembly including a collar removably attached to the neck, a pump configured to draw the liquid from the tank when actuated, and a housing defining a cavity therethrough to provide a carrying handle. A wand, separate from the tank, includes a body and a nozzle assembly, having a hub rotatably attached to the body and a plurality of nozzles circumferentially arranged around the hub and extending radially outwardly therefrom. An elongate hose, having a first end and a second end, interconnects the tank and the wand by attaching to the pump assembly of the tank at the first end and the body of the wand at the second end.

### CROSS-REFERENCE TO RELATED APPLICATIONS

This application relates to co-pending U.S. patent application Ser. No. ______, for “Spraying Apparatus,” filed on even date herewith; and Ser. No. ______, for “Nozzle Assembly for Spraying Apparatus,” filed on even date herewith, the entire disclosures of which are hereby incorporated by reference in their entirety including the drawings.

### BACKGROUND OF THE INVENTION

### 1. Field of the Invention

The present invention pertains to a spraying apparatus for spraying a liquid onto a surface.

### 2. Description of Related Art

Spray bottles may be used to dispense a liquid onto a surface. One such type of spray bottles includes a container or bottle, having a neck, that contains the liquid and a head attached to the neck of the bottle. The head includes a nozzle, a pump assembly, a trigger, and a tube. When the trigger is pulled, the pump assembly draws the liquid from the bottle via the tube and sprays the liquid out of the nozzle.

Lawn-and-garden sprayers and the like have a tank for storing a liquid therein and a wand connected to the tank by a hose. A pump system is provided on the tank and is used to pressurize a reservoir within the tank. The wand includes a valve that is operated by depressing a lever. Upon depressing the lever, the valve opens, and the liquid is expelled from the wand so long as the pressure within the reservoir is above atmospheric pressure.

Additionally, while each of the devices disclosed above are suitable for the uses and problems they intend to solve, there is an ongoing need for improvements in the design of a spraying apparatus, such as one that does not require a buildup of pressure within the tank of a sprayer, yet delivers a sufficiently strong stream of liquid.

It is to this to which the present invention is directed.

### SUMMARY OF THE INVENTION

According to one embodiment, a spraying apparatus for spraying a liquid onto a surface is disclosed. The spraying apparatus includes a tank defining a reservoir that stores a liquid; a hose; and a wand independently moveable of the tank and connected in fluid communication with the reservoir via the hose. The wand includes a body defining a barrel having a first fluid passageway in fluid communication with the hose and terminating at an outlet port; and a nozzle assembly having a hub and an array of nozzles circumferentially arranged around the hub. At least some of the array of nozzles each defining at least one aperture having a different configuration than the others. The hub is rotatable relative to the barrel to position one of the nozzles in fluid communication with the outlet port to select a corresponding configuration.

According to another embodiment, a spraying apparatus for spraying a liquid onto a surface is disclosed. The spraying apparatus includes a tank that stores a liquid; a neck extending from the tank and defining an opening; a pump assembly including a collar removably attached to the neck, a pump drawing the liquid from the tank when actuated, and a housing defining a cavity therethrough to provide a carrying handle; and a wand separate from the tank including a body and a nozzle assembly, the nozzle assembly having a hub rotatably attached to the body and a plurality of nozzles circumferentially arranged around the hub extending radially outward from the hub; and an elongate hose having a first end attached the pump assembly and a second end connected to the body. The pump assembly, the wand, and the elongate hose are separable from the tank by detaching the collar.

According to yet another embodiment, a spraying apparatus for spraying a liquid onto a surface is disclosed. The spraying apparatus includes a tank defining a reservoir that stores a liquid; and a pump assembly separate of the tank and connected to a hose. The pump assembly includes a body connected to the hose and defines a fluid passageway having an outlet port in fluid communication with the hose. The spraying apparatus further includes a nozzle assembly including a hub rotatably attached to the body and a plurality of nozzles circumferentially arranged around the hub and extending radially outward from the hub. At least some of the array of nozzles each defining at least one aperture having a different configuration from the others. The hub rotates relative to the body to place a desired one of the nozzles in fluid communication with the outlet port to select a corresponding configuration.

For a better understanding of the present invention, reference is made to the accompanying drawing and detailed description. In the drawing, like reference characters refer to like parts through the several views, in which:

### BRIEF DESCRIPTION OF THE DRAWING

FIG. 1 is a perspective view of a spraying apparatus in accordance with the present invention;

FIG. 2 is another perspective view of the spraying apparatus with an optional arm strap;

FIG. 3 is a side view of the spraying apparatus;

FIG. 4 is a perspective view of a rotatable nozzle assembly at the end of the spraying apparatus that includes a plurality of nozzle ends, each having a configuration, which are illustrated in front plan view in FIGS. 4A-4F;

FIG. 5 is an exploded side view of a barrel and hub of the nozzle assembly, illustrating the connecting relationship between the barrel and hub of the nozzle assembly;

FIG. 6 is a cross-sectional view of a portion of the spraying apparatus illustrating a pumping action to draw liquid through a suction tube, according to one embodiment;

FIG. 7 is a cross-sectional view of the suction tube and a piston assembly within the pump assembly of the spraying apparatus;

FIG. 8A is a perspective view of a collar connecting the neck of the tank to the pump assembly of the spraying apparatus;

FIG. 8B is a perspective view of a cap attached on the neck of the tank to close the tank during storage;

FIG. 9A is a perspective view of the optional arm strap;

FIG. 9B is a top view of the optional arm strap;

FIG. 10A is a first side view of a long strip of the optional arm strap;

FIG. 10B is a second side view of the long strip of the optional arm;

FIG. 10C is a first side view of a short strip of the optional arm strap;

FIG. 10D is a second side view of the short strip of the optional arm strap.

### DETAILED DESCRIPTION OF THE INVENTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

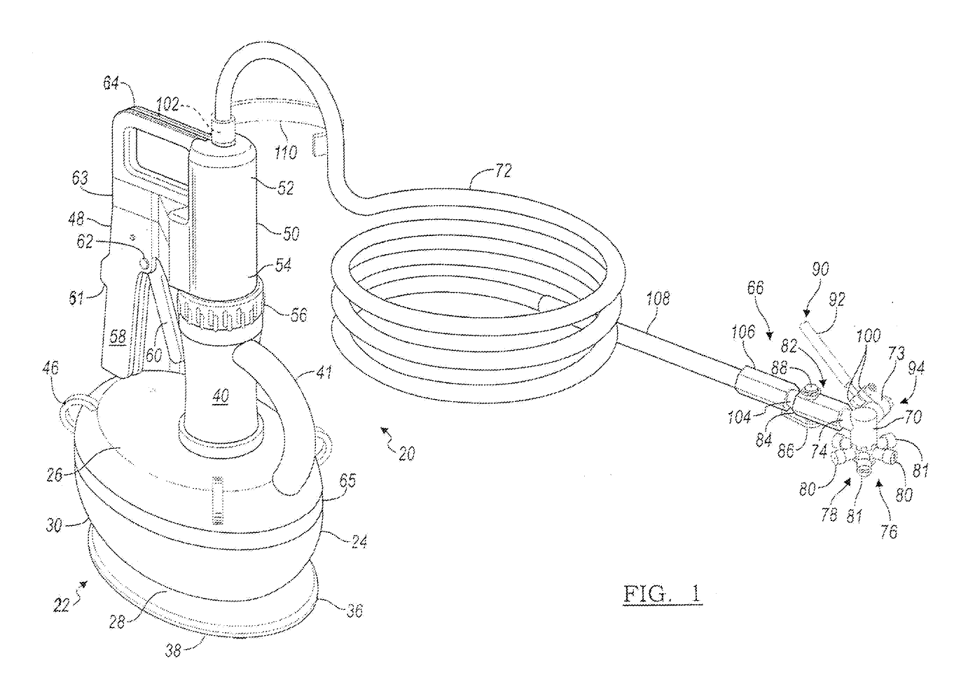

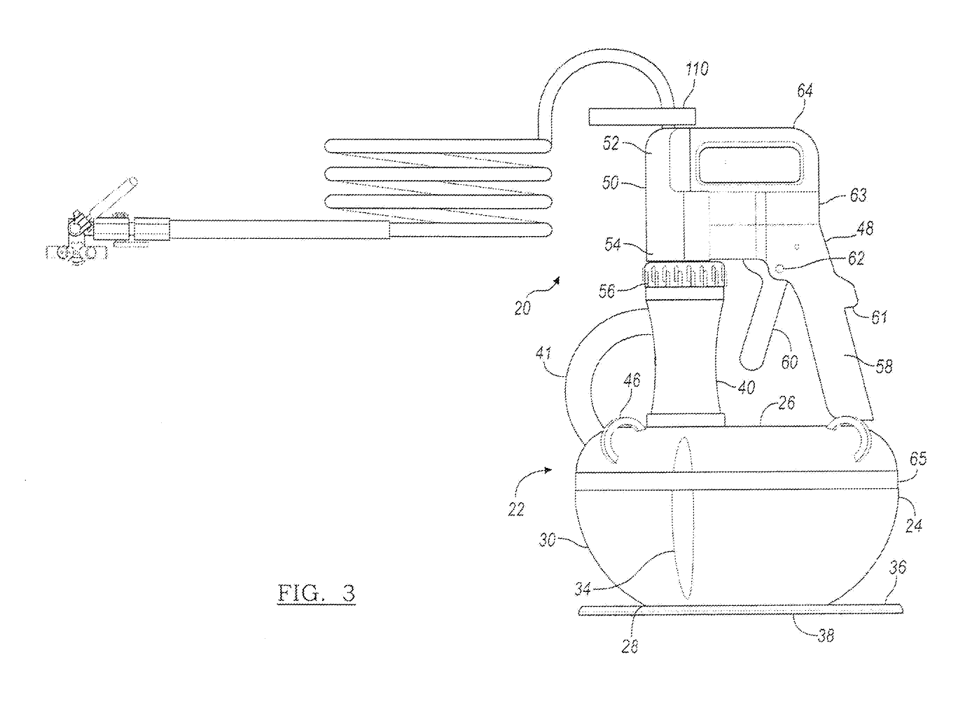

Referring to FIGS. 1-3, a spraying apparatus 20 includes a tank 22 having a main portion 24 with a top 26, a bottom 28, and at least one sidewall 30 interconnected to define a reservoir of the tank 22. The spraying apparatus 20 may be utilized to dispense a cleaning solution, and in other implementations, the spraying apparatus 20 may be utilized to dispense other types of liquids and solutions, such as fertilizer solutions. The reservoir of tank 22 is configured to store a liquid such as water, bleach, etc. The bottom 28 of the main portion 24 is connected to a base 36 that is configured to be supported on a floor or other surface, and to provide stability to the tank 22. The base 36 may be elliptical in shape and may include a nonskid bottom surface 38 that has a coefficient of friction that is greater than a coefficient of friction of the main portion 24 of the tank 22. Suitable materials for the base 36 include high density polyethylene (HDPE), chemically resistant plastic material, or other suitable plastic material. A suitable material for the nonskid bottom surface 38 is rubber, for example. The rubber may be overmolded onto the base 36 during a single forming operation to form the nonskid bottom surface 38. The tank 22 also includes a neck 40 that extends upwardly from the top 26 of the main portion 24. The neck 40 is hollow and defines an opening that allows liquid to be added or removed from the reservoir of the tank 22. The neck 40 may include a threaded portion (not shown) disposed on an upper end that connects with a pump assembly 48, as described below. The neck 40 can have a relatively large thickness to reinforce it for supporting the pump assembly 48. The tank 22 may include a carrying handle 41 that loops between the main portion 24 and the neck 40. The tank 22 can further include an optional body strap 65 for holding a hose 72, as described below, when in use or during storage.

The tank 22 may be made of any material suitable to hold a liquid such as metal, plastic, glass, ceramic, composite, or other material. The tank 22 may be available in a plurality of different materials to suit the specific chemical solution being utilized in order to provide a nonreactive and/or noncorrosive vessel for a range of different chemical solutions. The main portion 24 may include a window 34 allowing a user to see inside the tank to assess the fullness of the reservoir. The window 34 may be a transparent or translucent material such as glass or plastic. Alternatively, the tank 22 may include a gauge to measure the amount of liquid in the reservoir. The main portion 24 may also include a plurality of loops 46 that allow the tank 22 to be secured with bungee cords or other tie-downs to prevent the tank from moving or tipping during transporting or during use. Each of the plurality of loops 46 may have an internal cavity, which, in certain examples, the internal cavity is separated from the tank 22 through a dividing wall (not shown). The dividing walls inhibit liquid inside the tank 22 from entering the internal cavities of the loops 46 so that the inner surfaces of the loops 46 do not have to be cleaned. The carrying handle 41 may also have an internal cavity with a dividing wall (not shown) so that cleaning of the inner surface of the carrying handle 41 is not necessary.

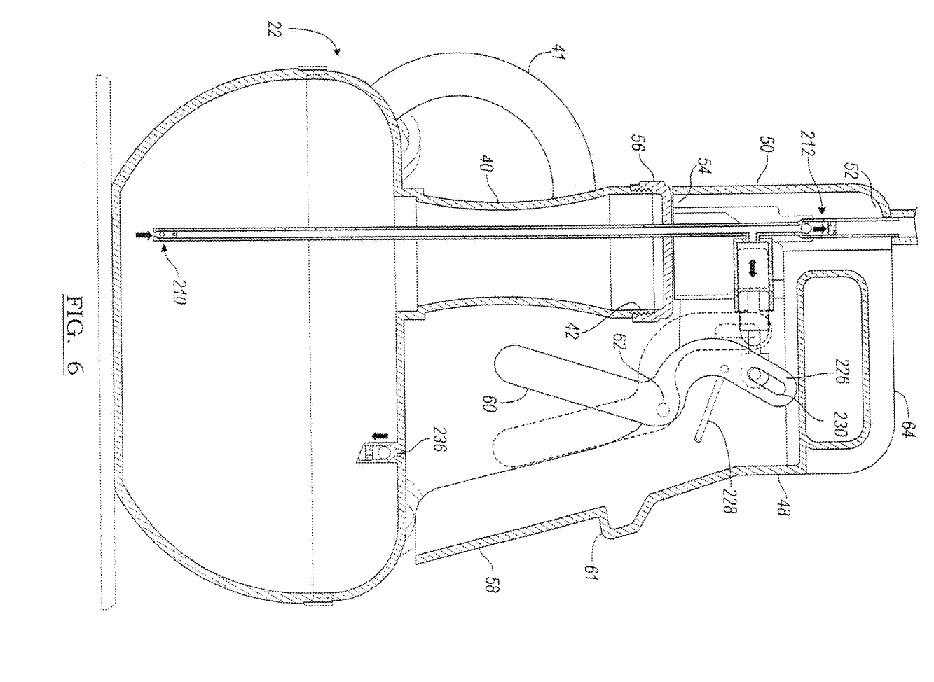

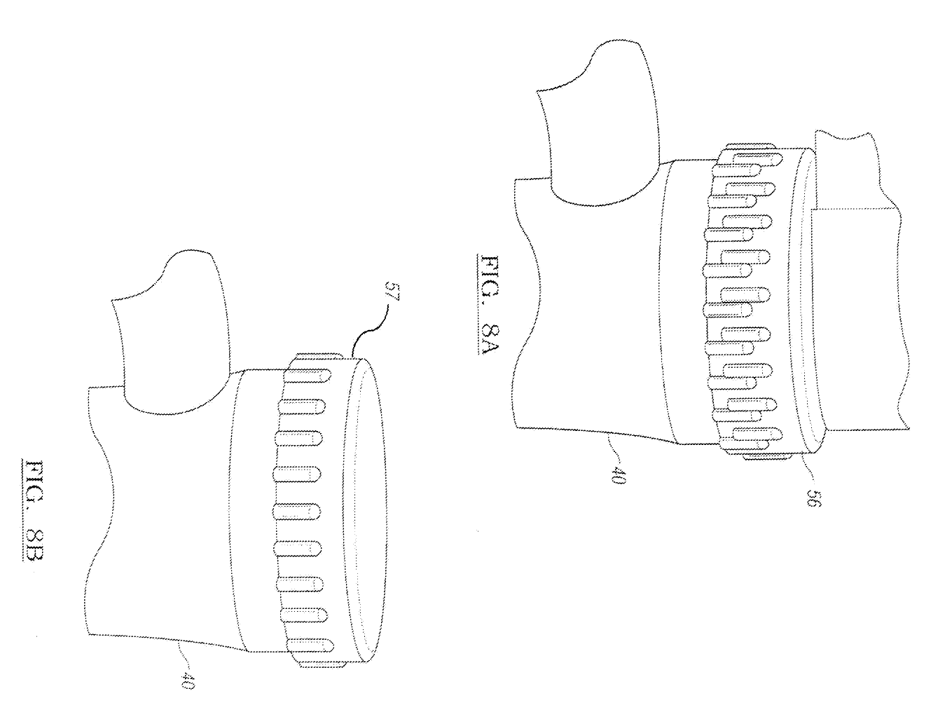

The pump assembly 48 may include a pump housing 50 having an upper end 52 and a lower end 54. The lower end 54 may include a collar 56 that is attachable to the neck 40. Referring to FIGS. 6 and 8A, the collar 56 may include threads that cooperate with a threaded portion 42 of the neck 40 to facilitate attaching and detaching the pump assembly 48 to the tank 22. The connection allows the pump assembly 48 to be completely detached from the tank 22. The pump housing 50 may comprise two or more modular components that can be separately removed to obtain access to the internal components of the pump assembly 48 for service and replacement. One such individual component is identified as component 63 on FIGS. 1-3.

Referring to FIG. 8B, a cap 57 may cover an opening formed at the top of the neck 40 when the pump assembly 48 is removed. The cap 57 may include threads, similar to that of the collar 56, which cooperate with the threaded portion 42 of the neck 40. Alternatively, another type of connection may be used as described herein, such as a press-fit connection.

Referring back to FIGS. 1-3, the pump assembly 48 also includes a grip member 58 and a trigger 60 to facilitate drawing liquid up from the tank 22. The trigger 60 is pivotably attached via a pin 62 and is moveable relative to the grip member 58 between a released position (shown in FIGS. 1-3) and a squeezed position (not shown). The grip member 58 also includes a stop 61 so that a user's hand does not slide up the grip member 58 into a difficult position to actuate the trigger 60. The pump assembly 48 also includes an upper handle 64 that may be used to carry the spraying apparatus 20 when the pump assembly 48 is connected to the neck 40. Alternatively, the upper handle 64 may be used to carry the pump assembly 48 when the pump assembly 48 is detached from the tank 22.

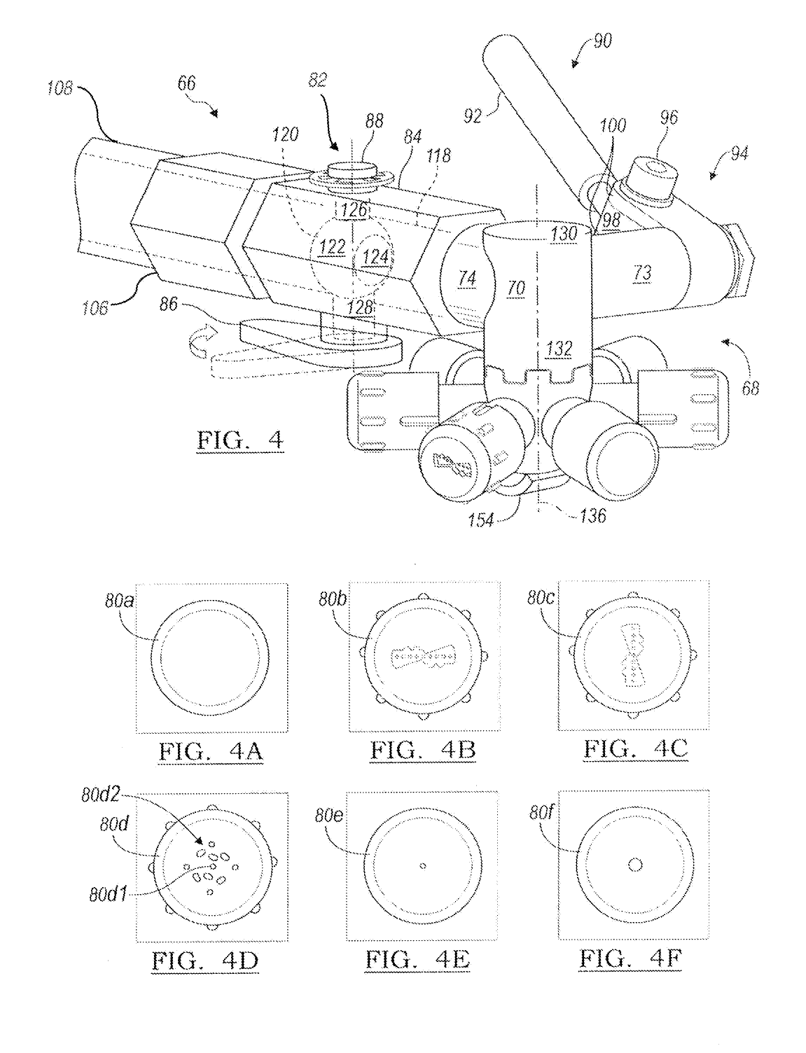

Referring now to FIGS. 1 and 4, the spraying apparatus 20 also includes a wand 66 that is connected to the tank 22 via the hose 72 for directing the spray of liquid towards an intended target. The wand 66 may be available in a plurality of different materials to suit the specific chemical solution being utilized in order to provide a nonreactive and/or noncorrosive vessel for a range of different chemical solutions. The wand 66 is separate from the tank 22 and is independently movable relative to the tank 22, thereby allowing a user to place the tank 22 on the ground next to the user and freely move the wand 66 in order to spray a liquid from inside the tank 22 onto a desired surface. The wand 66 includes a body 68 having a barrel 70, a first projection 73, and a second projection 74. The first and second projections 73, 74 may extend outwardly from the barrel 70 at an angle that is substantially perpendicular to the axial direction of the barrel 70. As used herein, “substantially” means within a tolerance of 0, 1, 2, 3, 4, 5, 6, 7, 8, 9, or 10 degrees or any range selected from any two of the identified values. Alternatively, the first and second projections 73, 74 may extend outwardly at angles that are not substantially perpendicular to the axial direction of the barrel 70, such as 15, 20, 30, 40, 50, 60, 70, 80, or 85 degrees or any range selected from any two of the identified values. The various components of the wand 66 may be integrally formed. For example, the entire body 68 may be a single-piece, ejection-molded component.

A nozzle assembly 76 is rotatably attached to the body 68. For example, the nozzle assembly 76 may include a disk shaped hub 78 having a rounded sidewall that is rotatably attached to the barrel 70. An array of nozzles 80 circumferentially arranged around the hub 78 and extend outwardly from the sidewall of the hub 78. Each nozzle 80 has a distal end 81. Each of the nozzles 80 is in fluid communication with the reservoir of the tank 22 and is configured to spray the liquid from the distal end 81 of the nozzle 80. Each of the distal ends 81 may define at least one aperture 160 that creates a unique configuration. Preferably, one of the distal ends 81 do not include any apertures 160, thereby acting as a safety nozzle to close off the liquid spray. Each of the nozzles 80 has an individual configuration, thereby providing a user with several choices of spraying and stream options from the wand 66. In the illustrated embodiment, the wand 66 includes three different spray patterns, three different stream sizes, and a safety nozzle. It is to be understood that the nozzle assembly 76 may include greater or fewer than six nozzles 80. Non-limiting examples of different configurations 80a-80f for the distal end 81 of the nozzles 80 are shown in FIGS. 4A-4F, respectively. For example, FIG. 4D depicts configuration 80d, which includes a sized stream 80d1 and a spray pattern 80d2.

The wand 66 also includes a valve assembly 82 for regulating the flow of the liquid through the body 68 and the nozzle assembly 76. The valve assembly 82 includes a tubular body 84 that connects with the second projection 74 on one end and the hose 72 on the other end. The valve assembly 82 may have a ball valve disposed on a shaft 88 and may be pivotable between fully open, fully closed, and a plurality of partially open positions. The shaft 88 may be connected with a lever 86 that allows a user to rotate the ball valve on the shaft 88 between different positions to control the flow of the liquid. The valve assembly 82 can also include one or more optional O-rings (not shown).

A wand handle 90 may be connected to the body 68 for further directing the wand 66. In one embodiment, the wand handle 90 includes a gripping rod 92. A clamp 94 secures the gripping rod 92 to the first projection 73. The clamp 94 may be C-shaped to include a projection-receiving portion and a pair of arms 100. The gripping rod 92 may include a perpendicular sleeve 98 that fits between the arms 100 such that a fastener 96 may extend through the arms 100 and through the sleeve 98 to connect the gripping rod 92 to the first projection 73. The fastener 96 may be loosened to allow the clamp 94 to pivot about the first projection 73 and to allow the sleeve 98 to pivot about the fastener 96. The axial direction of the first projection 73 and the axial direction of the fastener 96 may be substantially perpendicular to each other providing a large range of different positions for the gripping rod 92.

Referring to FIG. 4, the tubular body 84 of the valve assembly 82 defines a first fluid passage 118 that connects with the hose 72. A ball valve 120, having a ball 122, is disposed within the first fluid passage 118 and is sized such that an outer surface of the ball 122 is disposed against the walls of the first fluid passage 118. The ball 122 includes an aperture 124 that allows fluid to pass through the ball 122 when the ball valve 120 is at least partially open. The ball 122 is disposed on the shaft 88 such that the ball 122 is pivotable relative to the tubular body 84. The shaft 88 may be a pair of shafts that includes an upper shaft 126 and a lower shaft 128. The lever 86 may be connected to the lower shaft 128 to rotate the ball 122 to control the position of the ball 122 within the first fluid passage 118.

As described above, the nozzle assembly 76 is rotatably attached to the body 68 to allow a different one of the nozzles 80 to be selectively used. The position of the hub 78 and the barrel 70 may be variably fixed and rotated by interlocking teeth, or, alternatively, by a detent and pocket, or a ball and socket.

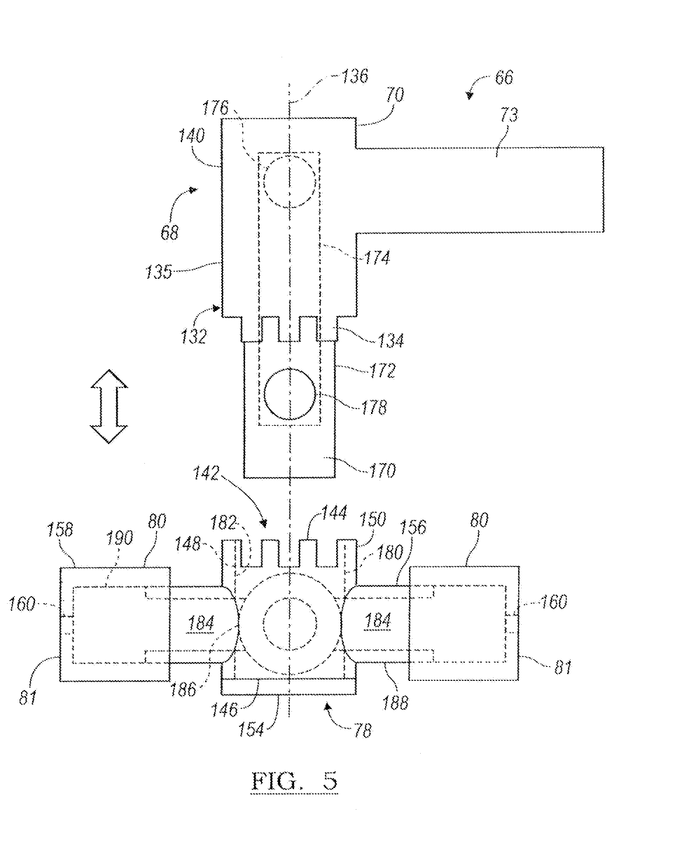

Referring to FIGS. 4 and 5, the barrel 70 may be tubular and include a top 130, a bottom 132, and at least one sidewall 135 extending therebetween. The first and second projections 73, 74 extend from the sidewall 135. The bottom 132 defines a downwardly facing first set of teeth 134 that mesh with a corresponding upwardly facing second set of teeth 144 defined by the top 142 of the hub 78. The hub 78 also includes a bottom 146 and at least one sidewall 148 extending therefrom. The barrel 70 and the hub 78 are arranged such that the center point of the hub 78 and the center point of the barrel 70 are axially aligned on the same axis 136. The barrel 70 and the hub 78 may be sized such that the outer surface 140 of the barrel 70 is flush with the outer surface 150 of the hub 78 when the teeth 134, 144 are interlocked. In order to rotate the hub 78 relative to the barrel 70, the hub 78 is first manually pulled downwardly away from the barrel 70 in an axial direction along the axis 136 to disengage the teeth 134, 144. The hub 78 is then rotated to position a desired nozzle 80 in fluid communication with the reservoir of the tank 22 after the hub 78 is returned to its original position and the teeth 134, 144 have been re-engaged. In one or more embodiments, a spring assembly 154 is used to maintain the teeth in the engaged position.

Each of the nozzles 80 may include a barrel 156 that projects outwardly from the outer surface 150 of the hub 78. The barrels 156 may be integrally formed with the hub 78. The barrel 156 may extend in an axial direction that is substantially perpendicular to axial direction 136. A cap 158 may be disposed over a portion of each barrel 156. One or more of the caps 158 may include a grip to allow the cap 158 to be rotated relative to the barrel 156. This rotatable movement, whether aided by a grip or not, allows the configuration of the nozzle 80 to be moved from an open position to a closed position and therebetween. The caps 158 and the barrels 156 may be integrally formed as a single piece for caps not intended to rotate. In some embodiments, the caps 158 are optional.

The caps 158 or the barrels 156 may define the distal end 81, which is oriented substantially perpendicular to the axial direction of the barrel 70. Depending upon the embodiment, the distal end 81 may define one or more apertures, or may not include any apertures. FIGS. 4A-4F illustrate different configurations. Configuration 80A does not include any apertures and is a safety nozzle that prevents fluid from spraying from the wand 66 and is a redundancy in case a user accidentally opens the valve 120 inadvertently, or the valve 120 fails. Moreover, the safety nozzle can inhibit excess liquid residing in the nozzle assembly 76 from exiting therefrom. Each of nozzles 80b, 80c, and 80d includes a different pattern of apertures. The apertures may have a uniform size as shown in FIG. 4B, or the apertures may be of varying size as shown in FIG. 4D. Configurations 80e and 80f each include only a single aperture, which are different sizes to provide different cross-sectional stream sizes. It is also contemplated to have a fully open nozzle head having a stream aperture similar to the diameter of that of a distal end 81.

Referring to FIGS. 4 and 5, barrel 70 includes a spindle 170 depending from the bottom surface 132. The barrel 70 and the spindle 170 may be integrally formed as a single piece. A second fluid passage 174 is defined within the body 68 and extends downwardly from the top 130 of the barrel 70 and into the spindle 170. The second fluid passage 174 includes an inlet port 176 disposed in the barrel 70, and an outlet port 178 defined by the spindle 170. The inlet port 176 is formed by a bore extending through the second projection 74. The bore defined by the second projection 74 is in fluid communication with the first fluid passage 118 of the valve assembly 82. If the body 68 is integrally formed, the bore in the second projection 74 and the second fluid passage 174 may be a continuous passage extending through the body 68.

The hub 78 defines a bore 180 having an inner surface 182. When assembled, the hub 78 is received on the spindle 170 such that the inner surface 182 is slidably received on the outer surface 172 of the spindle 170. As noted above, a spring assembly 154 connects with the bottom of the spindle 170 and retains the hub 78 on the spindle 170. The hub 78 can slide axially (e.g., up and down) along the spindle 170 to engage and disengage the teeth 134, 144 through adjusting the spring assembly 154 between a relaxed state to a flexed state. When the spring assembly 154 is in the flexed state, the hub 78 can rotate around the spindle 170 to cycle through the nozzles 80. Once the desired nozzle 80 is selected, the spring assembly 154 can be released, thereby returning the spring assembly 154 to its relaxed state, wherein the barrel 70 and hub 78 are contacting each other. As shown in FIG. 4, the spring assembly 154 is in the relaxed state. As shown in FIG. 5, the spring assembly 154 is in the flexed state.

Each of the caps 158 may include an inner surface 190 that is received on the outer surface 188 of a corresponding barrel 156. The caps 158 may be slidably received on the barrels 156, or may be fixed relative to the barrels with adhesive or other means.

Each of the barrels 156 defines a portion of a third fluid passage 184 that includes an inlet port 186 defined by the inner surface 182 of the bore 180. The third fluid passage 184 extends from the inlet port 186 to the distal end 81. In order to selectively provide liquid to only one of the nozzles 80, the spindle 170 only includes a single outlet port 178. During use, the user rotates the hub 78 relative to the spindle 170 to place a desired nozzle 80 in fluid communication with the outlet port 178.

During operation, liquid flows from the valve assembly 82 and into the barrel 70 via the inlet port 176. The liquid then flows downwardly through the second fluid passage 174 and out the outlet port 178. The outlet port 178 is adjacent to one of the inlet ports 186, allowing the liquid to flow into the third fluid passage 184 and out one or more of the apertures 160. The spindle 170 and the bore 180 may be sized to create a liquid-tight fit between the outer surface 172 of the spindle 170 and the inner surface 182 of the bore 180 to force the liquid flowing through the outlet port 178 into the third fluid passage 184.

The hose 72 includes a proximal end 102, which connects to the upper end 52 of the pump housing 50, and a distal end 104, which includes a fitting 106 that connects with the valve assembly 82 of the wand 66. In one example, the fitting 106 and the distal end 104 of the hose 72 are adhesively connected, although in other examples, other connections can be used such as press-fit or threaded connections. The fitting 106 and the nozzle assembly 76 are in threaded connection, although other connections are contemplated, such as friction fit or adhesive connection. The proximal end 102 may also include a threaded connection for connecting to the pump housing 50, but other connections are contemplated, such as friction fit or adhesive connection. The hose 72 may be made out of any material for flexible tubing and can have more than one layer, such as a double-wall with two layers. A sleeve 108 may surround the hose 72 near the distal end 104. The sleeve 108 may be padded to provide comfort to the user. The sleeve 108 may also be stiff and, therefore, usable as an elongated handle for extra reach and control. A Velcro® strap 110 can also be used to bundle and reduce the length of the hose 72 when the spraying apparatus 20 is in use.

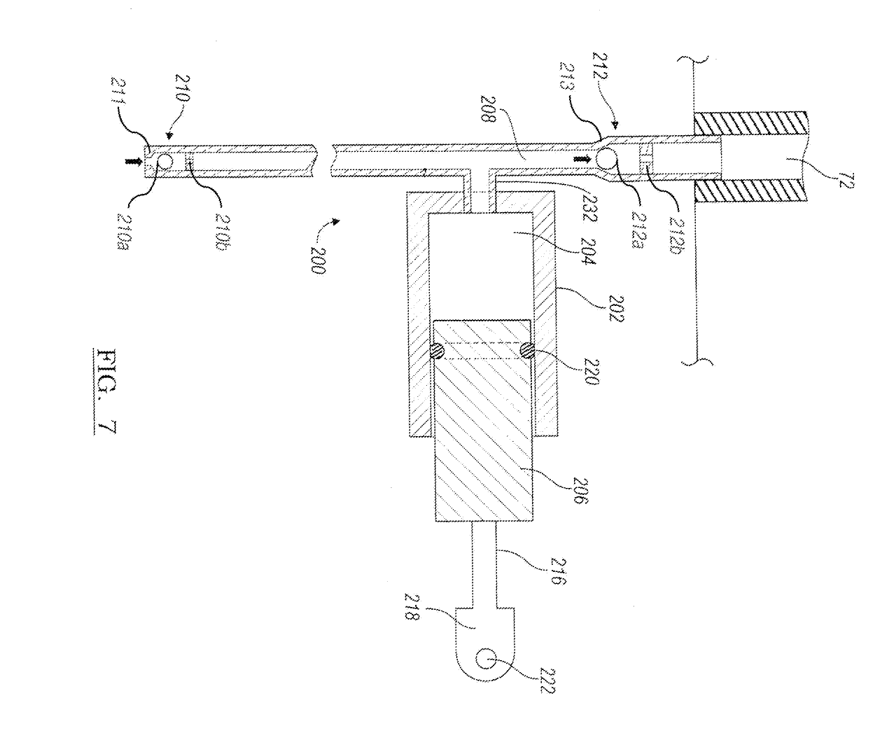

Referring now to FIGS. 6 and 7, the pump assembly 48 includes a pump subassembly 200 disposed within the pump housing 50. The pump subassembly 200 includes a cylinder 202 and a piston 206 slidably received within the cylinder 202. The piston 206 may optionally include a circular groove (not shown) that receives one or more O-rings 220. The cylinder 202 and the piston 206 cooperate to define a chamber 204 that increases and decreases in volume depending upon the position of the piston 206 relative to the cylinder 202. The chamber 204 is connected in fluid communication with a siphon tube 208 that extends downwardly into the reservoir of the tank 22 and extends upwardly to connect with the hose 72. The siphon tube 208 can be made of one or more tube segments. The piston 206 includes a rod 216 having an enlarged end 218 that couples to a head 226 of the trigger 60. The enlarged end 218 may include a pin 222 that is received within a slot 230 defined in the head 226. The components of the pump subassembly 200 may be made of any material suitable to hold a liquid such as metal, plastic, glass, ceramic, composite, or other material. These components may be available in a plurality of different materials to suit the specific chemical solution being utilized in order to provide a nonreactive and/or noncorrosive vessel for a range of different chemical solutions.

The trigger 60 is actuatable between a released position (shown in solid lines) and a squeezed position (shown in broken lines). A spring 228 holds the trigger 60 in the released position. Actuation of the trigger 60 slides the piston 206 within the cylinder 202. When the trigger 60 is in the released position, the piston 206 is located in a retracted position creating the largest volume in the chamber 204. When in the squeezed position, the piston 206 is located in an extended position creating the smallest volume in the chamber 204.

When the trigger 60 is squeezed, the piston 206 extends to pressurize fluid or air in the chamber 204. The positive pressure within the chamber 204 forces the fluid out of an outlet port 232 defined in a wall of the cylinder 202 into the siphon tube 208, and then into the hose 72. A lower one-way valve 210, which includes a ball 210a, that sits within a lower restriction 211, and a stopper 210b disposed on (or in) the siphon tube 208, prevents fluid from flowing from the chamber 204 into the reservoir of the tank 22. When the trigger 60 is released, the piston 206 retracts creating suction within the chamber 204 to draw liquid from the reservoir of the tank 22 into the chamber 204. An upper one-way valve 212, which includes a ball 212a, that sits within an upper restriction 213, and a stopper 212b, prevents fluid from flowing from the hose 72 to the chamber 204. Beneficially, the siphon tube 208 and hose 72, once primed, remains full for at least the current use period. The stoppers 210b, 212b may include a plurality of perforations to allow fluid to flow through the siphon tube into the hose 72.

Unlike typical lawn-and-garden sprayers and the like that pressurize the tank, the tank 22 of the present invention remains near atmospheric pressure because the squeezing of the trigger 60 pressurizes the cylinder 204 and the hose 72 without pressurizing the tank 22. The lower one-way valve 210 prevents the piston 206 from driving fluid or air into the tank 22, thereby preventing the piston 206 from pressurizing the tank 22. A third one-way valve 236 is provided on the top 26 of the tank 22 and is configured to let air flow from only outside of the tank 22 to inside the tank 22 preventing a negative pressure from being created in the tank 22. Accordingly, a user may operate the spraying apparatus 20 when it is detached from the tank 22. In contrast, the typical lawn-and-garden sprayer cannot be used without the tank because the tank is the portion of the sprayer that is pressurized. Moreover, the hose is typically attached to the tank and not to a pump assembly.

While the figures illustrate the one-way valves 210, 212, 236 as being ball valves, other one-way valves are contemplated, the structure of which is known to those of ordinary skill in the art.

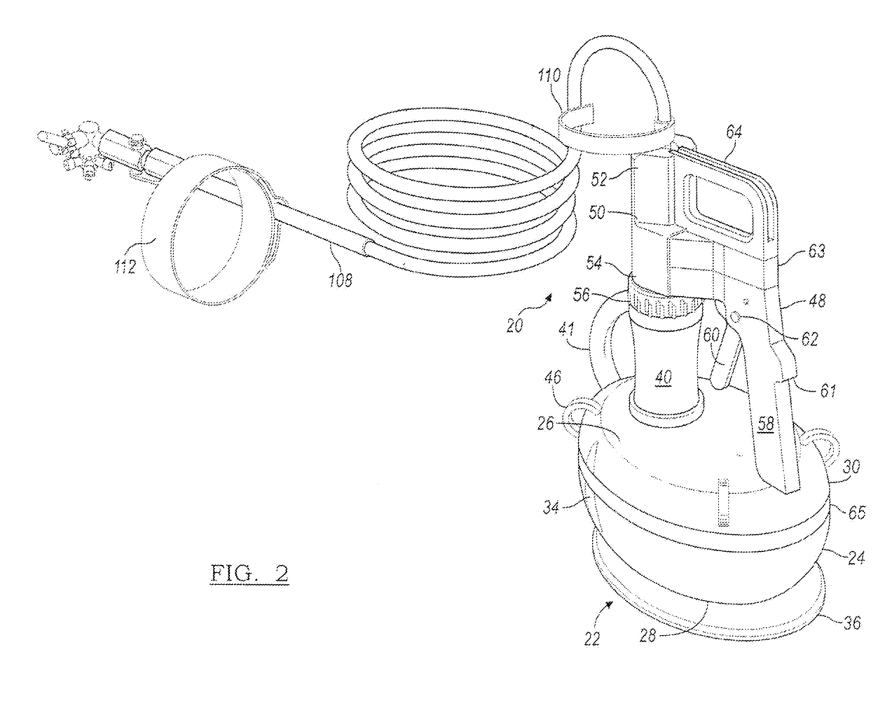

As shown in FIG. 2, an optional arm strap 112 may be provided on the sleeve 108 to attach the sleeve 108 of the hose 72 to a user's forearm, or other body part. The arm strap 112 may be provided for holding the hose 72 close to the forearm of the user. When the arm strap 112 is attached to the forearm or upper arm of the user, the nozzle assembly 76 can be easily manipulated by the user, and additionally controlled by using the wand handle 90. A second optional arm strap 112 may be provided closer to the proximal end 102 of the hose 72 for attaching hose 72 to a user's upper arm.

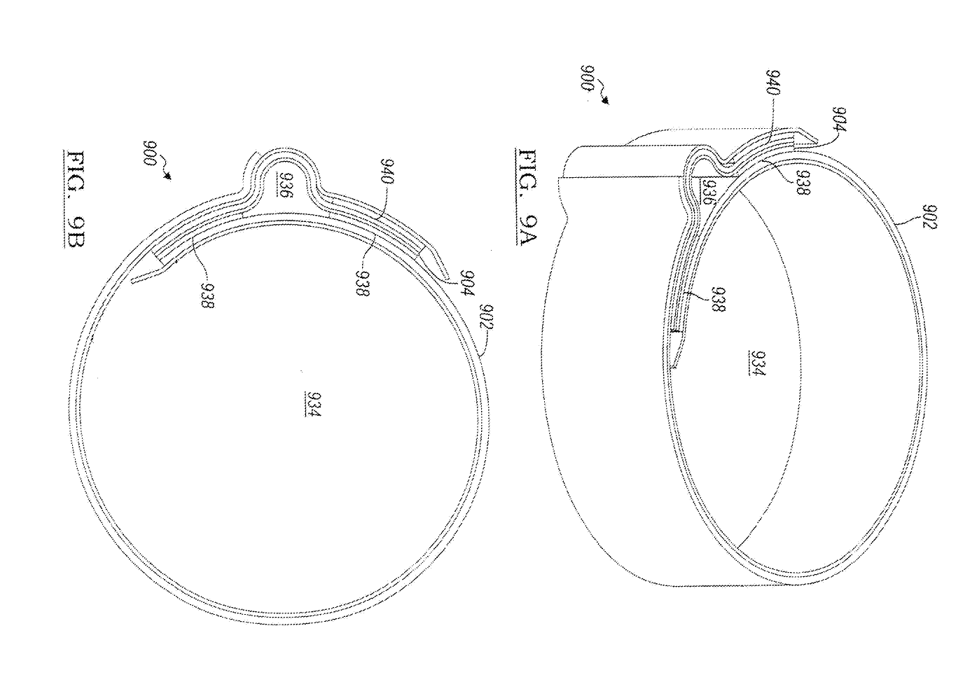

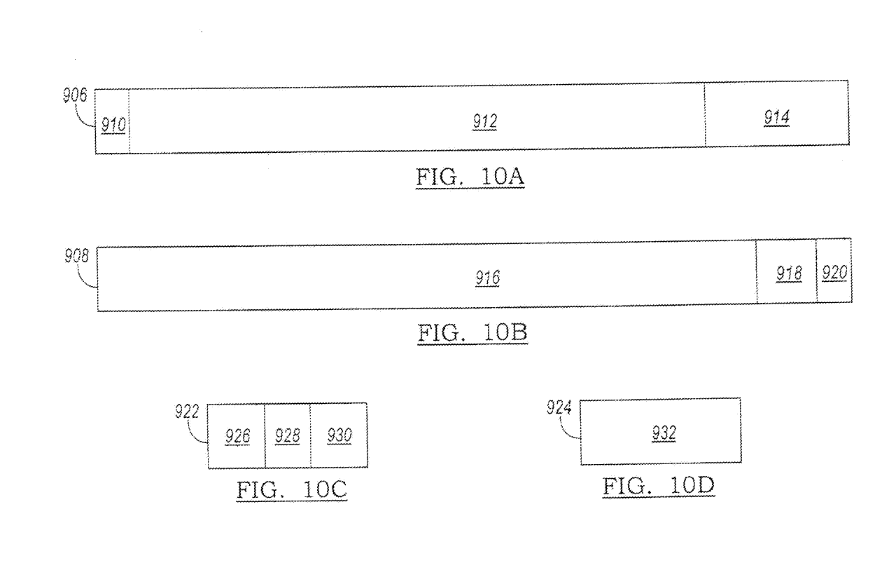

As shown in FIGS. 9A, 9B, 10A, and 10B, a specific embodiment of the arm strap 112 is illustrated as an optional arm strap 900. The optional arm strap 900 includes a long strip portion 902 and a short strip portion 904. As shown in FIGS. 10A, and 10B, the long strip portion 902 includes a first side 906 and a second side 908. The long strip portion 902 is constructed of a base material, such as a stretch elastic material. The first and second sides 906, 908 are characterized in that an attachment material, such as a Velcro® material, is attached to the base material. The first side 906 includes a first portion 910 that is exposed in that there is no additional material attached to the base material. The first side 906 also includes a second portion 912 in which a female fastening material is attached to the base material. The female fastening material may be the loop side of a Velcro® material. The first side 906 further includes a third portion 914 that is exposed base material. The second side 908 includes a first portion 916 that is exposed base material. The second side 908 also includes a second portion 918 in which a male fastening material is attached to the base material. The male fastening material may be the hook side of a Velcro® material. The second side 908 further includes a third portion 920 that is exposed base material. The third portion 920 functions as a point for the user to grasp and facilitate wrapping the arm strap 900. Wherever a female or male fastening material is utilized, the opposite type of fastening material can be utilized provided that the two materials are opposite each other in a fastening area. The lengths and widths of any of the portions shown can be adjusted based on the diameter of the object, e.g., a user's forearm or upper arm.

As noted above, the optional arm strap 900 further includes a short strip portion 904. The short strip portion 904 includes a first side 922 and a second side 924. The short strip portion 904 is constructed of a base material, such as a stretch elastic material. The first and second sides 922, 924 are characterized in that an attachment material, such as a Velcro® material, is attached to the base material. The first side 922 includes a first, second, and third portion 926, 928, 930, respectively. The first and third portions 926, 930 have a male fastening material attached to the base material. The male fastening material may be the hook side of a Velcro® material. The second portion 928 is exposed to the base material. The second side 924 includes a female fastening portion 932 that runs the length and the width of the second side 924. Wherever a female or male fastening material is utilized, the opposite type of fastening material can be utilized provided that the two materials are opposite each other in a fastening area. The lengths and widths of any of the portions can be adjusted based on the diameter of the object, e.g., a user's forearm or upper arm.

As shown in FIGS. 9A and 9B, the long strip 902 is wrapped around itself to form a first aperture 934 for receiving and holding an object, such as the arm of a user that is using the spraying apparatus 20 and a second aperture 936 for receiving and holding the hose 72. The short strip 904 is situated between the first and second sides 906, 908 of the long strip 902 when in its wrapped configuration. The first side 906 of the long strip 902 faces the first side 922 of the short strip 904, thereby forming a first fastening area 938 between opposing attachment materials. The second side 908 of the long strip 902 faces the second side 924 of the short strip 904, thereby forming a second fastening area 940 between opposing attachment materials.

An exemplary use of the spraying apparatus 20 will now be described. The user can add the desired fluid to the tank 22 and either store the tank 22 with the provided cap 57, or if ready for use, use the threaded collar 56. The user than selects a desired configuration 80a-80d by rotating the nozzle assembly 76 so that the desired configuration is aligned with the outlet port 178. The user can then rotate the lever 86 to the open position. The spraying apparatus 20 is now ready for use. The user can squeeze and release the trigger 60 to generate linear motion of the piston 206 within the cylinder 202. This creates an alternating vacuum and positive pressure scenario within the siphon tube 208 inside the tank 22. When the trigger 60 is squeezed, the upper one-way valve 212 is open while the lower valve 210 is closed, and vice versa when the trigger 60 is released.

When the trigger 60 is squeezed, the piston 206 moves forward causing a positive pressure build up in the chamber 204 and the lower one-way valve 210 at the bottom region of the siphon tube 208 is forced closed. Meanwhile, the upper one-way valve 212 at the top region of the siphon tube 208 is pressurized and opened.

When the trigger 60 is released, the spring 228 pulls the trigger 60 back to the released position. This action draws the piston 206 outward, creating a vacuum in the chamber 204, which draws fluid up the siphon tube 208 from the tank 22 and into the chamber 204. The continuous action of cycling the trigger 60, cycles the valves 210, 212 in the open and closed positions opposite to one another, allowing a continuous flow of liquid through the hose 72 and into the nozzle assembly 76. While the fluid is being pumped from the tank 22 into the nozzle assembly 76, a third one-way valve 236 on the tank 22 also cycles between open and closed positions, allowing air to enter the tank 22 to maintain an atmospheric pressure.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depends on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

20 Spraying apparatus
22 Tank
24 Main portion of tank
26 Top of main portion
28 Bottom of main portion
30 Sidewall of main portion
34 Window in main portion
36 Base
38 Bottom surface of base
40 Neck of tank
41 Carrying handle of tank
42 Threaded portion of neck
46 Loops of main portion
48 Pump assembly
50 Pump housing
52 Upper end of pump housing
54 Lower end of pump housing
56 Collar
57 Cap
58 Grip member of pump assembly
60 Trigger of pump assembly
61 Stop on grip member
62 Pin
63 Component of pump housing
64 Upper handle of grip member
65 Body strap of tank
66 Wand
68 Body of wand
70 Barrel of wand
72 Hose
73 First projection of wand
74 Second projection of wand
76 Nozzle assembly
78 Hub
80 Nozzle
80a Configuration of distal end of nozzle
80b Configuration of distal end of nozzle
80c Configuration of distal end of nozzle
80d Configuration of distal end of nozzle
80d1 Sized stream
80d2 Spray pattern
80e Configuration of distal end of nozzle
80f Configuration of distal end of nozzle
81 Distal end of nozzle
82 Valve assembly
84 Tubular body of valve assembly
86 Lever of valve assembly
88 Shaft of valve assembly
90 Wand handle
92 Gripping rod of wand handle
94 Clamp of wand handle
96 Fastener of wand handle
98 Sleeve of wand handle
100 Arms of clamp
102 Proximal end of hose
104 Distal end of hose
106 Fitting of hose
108 Sleeve of hose
110 Velcro® Strap
112 Arm strap
118 First fluid passage between valve assembly and hose
120 Ball valve
122 Ball
124 Aperture of ball
126 Upper shaft of shaft
128 Lower shaft of shaft
130 Top of barrel
132 Bottom of barrel
134 Teeth of barrel
135 Sidewall of barrel
136 Axis
140 Outer surface of barrel
150 Outer surface of hub
142 Top of hub
144 Teeth of hub
146 Bottom of hub
148 Sidewall of hub
154 Spring assembly
156 Barrel of nozzle
158 Cap
160 Apertures
170 Spindle
172 Outer surface of spindle
174 Second fluid passage
176 Inlet port
178 Outlet port
180 Bore
182 Inner surface of bore
184 Third fluid passage
186 Inlet port
188 Outer surface of barrel
190 Inner surface of cap
200 Pump subassembly
202 Cylinder
204 Chamber
206 Piston
208 Siphon tube
210 Lower one-way valve
210a Ball
210b Stopper
211 Lower restriction
212 Upper one-way valve
212a Ball
212b Stopper
213 Upper restriction
216 Rod
218 Enlarged end of rod
220 O-ring
222 Pin
226 Head of trigger
228 Spring
230 Slot
232 Outlet port
236 Third one-way valve
900 Arm strap
902 Long strip portion
904 Short strip portion
906 First side of long strip portion
908 Second side of long strip portion
910 First portion of first side of long strip portion
912 Second portion of first side of long strip portion
914 Third portion of first side of long strip portion
916 First portion of second side of long strip portion
918 Second portion of second side of long strip portion
920 Third portion of second side of long strip portion
922 First side of short strip portion
924 Second side of short strip portion
926 First portion of first side of short strip portion
928 Second portion of first side of short strip portion
930 Third portion of first side of short strip portion
932 Female fastening portion of second side of short strip portion
934 First aperture formed in long strip portion
936 Second aperture formed in long strip portion
938 First fastening area
940 Second fastening area

Having thus described the invention, what is claimed is:

1. A pump assembly for a spraying apparatus, the pump assembly comprising:
(a) a housing;
(b) a cylinder situated in the housing;
(c) a piston situated in the cylinder and translatable within the cylinder for movement between a first position and a second position, when the piston is in the first position, the piston forms a chamber with the cylinder, when the piston is in the second position, the piston occupies at least a portion of the chamber;
(d) an outlet port extending beyond a distal end of the cylinder; and
(e) a siphon tube connected to the outlet port and having an inlet end and an outlet end, when the piston is translated from the first position to the second position, fluid residing in the cylinder exits the cylinder through the outlet port and enters the siphon tube.

2. The pump assembly of claim 1, wherein the inlet end of the siphon tube is situated below the outlet port and the outlet end of the siphon tube is situated above the outlet port.

3. The pump assembly of claim 2, wherein when the piston is translated from the second position to the first position, fluid residing in a reservoir exits the reservoir through the inlet end and enters the siphon tube.

4. The pump assembly of claim 1, further comprising an upper one-way valve situated proximate to the outlet end and allows fluid to exit the outlet end, the upper one-way valve further prevents fluid from re-entering the outlet end.

5. The pump assembly of claim 1, further comprising a lower one-way valve situated proximate to the inlet end allows fluid to enter the siphon tube through the inlet end, the lower one-way valve further prevents fluid from exiting the siphon tube through the inlet end.

6. The pump assembly of claim 1, wherein the cylinder includes a cylindrical side wall and an end wall, the outlet port extends from the end wall away from the cylinder.

7. The pump assembly of claim 1, further comprising an O-ring fitted around an outer perimeter of the piston.

8. The pump assembly of claim 7, wherein the piston includes a circular groove that receives the O-ring.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
